(19) United States
(12) Patent Application Publication
(10) Pub. No.: US 2022/0327650 A1
(43) Pub. Date: Oct. 13, 2022

(54) TRANSPORTATION BUBBLING AT A RIDE-HAILING PLATFORM AND MACHINE LEARNING

(71) Applicant: Beijing DiDi Infinity Technology and Development Co., Ltd., Beijing (CN)

(72) Inventors: Wenjie SHANG, BEIJING (CN); Qingyang LI, SUNNYVALE, CA (US); Zhiwei QIN, SAN JOSE, CA (US)

(21) Appl. No.: 17/220,798

(22) Filed: Apr. 1, 2021

(51) Int. Cl. G06Q 50/30; G06N 20/00; G06N 7/00; G06N 5/04; G06Q 30/02; G06Q 10/06; G01C 21/34

(52) U.S. Cl. CPC G06Q 50/30; G06N 20/00; G06N 7/005; G06N 5/04; G06Q 30/0205; G06Q 30/0224; G06Q 10/06315; G06Q 30/0206; G06Q 30/0219; G01C 21/3438; G01S 19/51

(57) ABSTRACT

A computer-implemented method includes: training a machine learning model with training data to obtain a long-term value model, wherein the training data comprises a plurality of series of temporally-sequenced user bubbling events, wherein each of the user bubbling events corresponds to a historical transportation query from a user device and a historical response including a historical discount signal from a server, and wherein the long-term value model is configured to predict long-term values for respectively applying different discount signals to a given transportation plan of given bubbling features; obtaining a plurality of bubbling features of a transportation plan of a user, wherein the plurality of bubbling features; determining a discount signal based at least on feeding the plurality of bubbling features to the long-term value model; and transmitting the discount signal to a computing device of the user.

### TECHNICAL FIELD

The disclosure relates generally to deep reinforcement learning based on training data including transportation bubbling at a ride-hailing platform.

### BACKGROUND

Online ride-hailing platforms are rapidly becoming essential components of the modern transit infrastructure. Online ride-hailing platforms connect vehicles or vehicle drivers offering transportation services with users looking for rides. For example, a user may log into a mobile phone APP or a website of an online ride-hailing platform and submit a request for transportation service—the whole process can be referred to as bubbling. For example, a user may enter the starting and ending locations of a transportation trip through bubbling to receive an estimated price with or without an incentive.

The computing system of the online ride-hailing platform often needs to know which incentive policy is more effective and accordingly implement a solution that can automatically make incentive decisions in real-time. However, it is practically impossible for human minds to evaluate these policies and make incentive decisions on the on-line platform scale. Moreover, non-machine learning methods in these areas are often inaccurate because of the large number of factors involved and their complicated latent relations with the policy. Further, performing evaluations online in real-time is impractical because of its high cost and disruption to regular service.

### SUMMARY

Various embodiments of the specification include, but are not limited to, systems, methods, and non-transitory computer-readable media for machine learning and application at a ride-hailing platform.

In some embodiments, a computer-implemented method for machine learning and application at a ride-hailing platform comprises: training, by one or more computing devices, a machine learning model with training data to obtain a long-term value model, wherein the training data comprises a plurality of series of temporally-sequenced user bubbling events, wherein each of the user bubbling events corresponds to a historical transportation query from a user device and a historical response including a historical discount signal from a server, and wherein the long-term value model is configured to predict long-term values for respectively applying different discount signals to a given transportation plan of given bubbling features; obtaining, by the one or more computing devices, a plurality of bubbling features of a transportation plan of a user, wherein the plurality of bubbling features comprise (i) a bubble signal comprising time information and location information corresponding to the transportation plan, (ii) a supply and demand signal comprising transportation supply-demand information corresponding to the transportation plan, and (iii) transportation order history information of the user; determining, by the one or more computing devices, a discount signal based at least on feeding the plurality of bubbling features to the long-term value model; and transmitting, by the one or more computing devices, the discount signal to a computing device of the user.

In some embodiments, the method further comprises: collecting, by the one or more computing devices, historical user bubbling events corresponding to the historical users bubbling at different historical times; and formulating, by the one or more computing devices, historical user bubbling events of each of the historical users into a Markov Decision Process (MDP) trajectory to obtain the plurality of series of temporally-sequenced user bubbling events.

In some embodiments, the historical user bubbling events respectively correspond to transitions in reinforcement learning; the method further comprises assigning greater weights to transitions with greater temporal difference (TD) errors, more recent transitions, and/or stochastic transitions; and training the machine learning model with training data comprises randomly sampling the transitions from the training data according to the assigned weights.

In some embodiments, the MDP trajectory comprises a quintuple (S, A, T, R, γ); S represents a state space comprising a plurality of states corresponding to the bubbling features of the historical users; A represents an action space comprising a plurality of actions corresponding to the historical discount strategies applied to the historical users; T represents a state transition model based on S and A; R represents a reward function based on S and A; and γ represents a discount factor of a cumulative reward.

In some embodiments, training the machine learning model comprises: enabling a reinforcement learning agent to, until reaching a terminal state, learn from interactions with a reinforcement learning environment, wherein the reinforcement learning agent is configured to observe a state s from the environment, select an action α given by a policy π to execute in the environment, and then observe a next state s+1 and obtain a reward r corresponding to the state transition from s to s+1 with the action α, wherein the policy π is based at least on one or more weights and/or one or more biases; and optimizing the policy π based at least on tuning the one or more weights and/or the one or more biases.

In some embodiments, the state s corresponds to a historical bubbling event; the action α corresponds to a historical discount signal; and the reward r is based at least on a product between (i) a price of a historical transportation completed from the historical bubbling event and (ii) a change between a first conversion rate of conversion from a bubbling event to a transportation order with discount and a second conversion rate of conversion from a bubbling event to a transportation order without discount.

In some embodiments, the plurality of actions comprise: a number (N) of discrete discounts and no discount.

In some embodiments, optimizing the policy π comprises: applying a double-Q learning algorithm configured to maximize an expectation of the cumulative reward subject to the discount γ and optimize the selection of the action α from the plurality of actions of the action space.

In some embodiments, the machine learning model comprises a representation encoder, a dueling network, and an aggregator; the dueling network comprises a first stream and a second stream configured to share the encoder and outcouple to the aggregator; the first stream is configured to estimate the reward r corresponding to the state s and the action α; and the second stream is configured to estimate a difference between the reward r and an average.

In some embodiments, the location information comprises an origin location of the transportation plan of the user, a destination location of the transportation plan, a distance between the origin location and the destination location, and a route departing from the origin location and arriving at the destination location; the time information comprises a timestamp, and a vehicle travel duration along the route; and the transportation supply-demand information comprises a number of passenger-seeking vehicles around the origin location and a number of vehicle-seeking transportation orders departing from the origin location.

In some embodiments, the origin location of the transportation plan of the user comprises a geographical positioning signal of the computing device of the user; and obtaining the supply and demand signal comprises: obtaining, from a plurality of computing devices of a plurality of vehicle drivers, a plurality of geographical positioning signals respectively corresponding to the plurality of computing devices of the plurality vehicle drivers; and determining the number of passenger-seeking vehicles around the origin based on the plurality of geographical positioning signals and the geographical positioning signal of the computing device of the user.

In some embodiments, the geographical positioning signal comprises a Global Positioning System (GPS) signal; and the plurality of geographical positioning signals comprise a plurality of GPS signals.

In some embodiments, the location information further comprises one or more of the following: a weather condition at one or more locations along the route; and a traffic condition at one or more locations along the route.

In some embodiments, the bubble signal further comprises a price quote corresponding to the transportation plan; and the method further comprises presenting, by the computing device of the user, the discount signal, the route, and the price quote.

In some embodiments, the method further comprises: receiving, by the one or more computing devices, from the computing device of the user, an acceptance signal comprising an acceptance of the transportation plan of the user, the price quote, and a price discount corresponding to the discount signal; and transmitting, by the one or more computing devices, the transportation plan to a computing device of a vehicle driver for fulfilling the transportation order.

In some embodiments, the transportation order history information of the user comprises one or more of the following: a frequency of order transportation order bubbling by the user; a frequency of transportation order completion by the user; a history of discount offers provided to the user in response to the order transportation order bubbling; and a history of responses of the user to the discount offers.

In some embodiments, the long-term value model is configured to: generate a value matrix that maps to combinations of different users and different discount signals; and automatically perform discount signal determination based on the given bubbling features and the value matrix to optimize a long-term return to the ride-hailing platform and comply with a budget constraint.

In some embodiments, one or more non-transitory computer-readable storage media stores instructions executable by one or more processors, wherein execution of the instructions causes the one or more processors to perform operations comprising: training a machine learning model with training data to obtain a long-term value model, wherein the training data comprises a plurality of series of temporally-sequenced user bubbling events, wherein each of the user bubbling events corresponds to a historical transportation query from a user device and a historical response including a historical discount signal from a server, and wherein the long-term value model is configured to predict long-term values for respectively applying different discount signals to a given transportation plan of given bubbling features; obtaining a plurality of bubbling features of a transportation plan of a user, wherein the plurality of bubbling features comprise (i) a bubble signal comprising time information and location information corresponding to the transportation plan, (ii) a supply and demand signal comprising transportation supply-demand information corresponding to the transportation plan, and (iii) transportation order history information of the user; determining a discount signal based at least on feeding the plurality of bubbling features to the long-term value model; and transmitting the discount signal to a computing device of the user.

In some embodiments, a system comprises one or more processors and one or more non-transitory computer-readable memories coupled to the one or more processors and configured with instructions executable by the one or more processors to cause the system to perform operations comprising: training a machine learning model with training data to obtain a long-term value model, wherein the training data comprises a plurality of series of temporally-sequenced user bubbling events, wherein each of the user bubbling events corresponds to a historical transportation query from a user device and a historical response including a historical discount signal from a server, and wherein the long-term value model is configured to predict long-term values for respectively applying different discount signals to a given transportation plan of given bubbling features; obtaining a plurality of bubbling features of a transportation plan of a user, wherein the plurality of bubbling features comprise (i) a bubble signal comprising time information and location information corresponding to the transportation plan, (ii) a supply and demand signal comprising transportation supply-demand information corresponding to the transportation plan, and (iii) transportation order history information of the user; determining a discount signal based at least on feeding the plurality of bubbling features to the long-term value model; and transmitting the discount signal to a computing device of the user.

In some embodiments, a computer system includes a training module configured to train a machine learning model with training data to obtain a long-term value model, wherein the training data comprises a plurality of series of temporally-sequenced user bubbling events, wherein each of the user bubbling events corresponds to a historical transportation query from a user device and a historical response including a historical discount signal from a server, and wherein the long-term value model is configured to predict long-term values for respectively applying different discount signals to a given transportation plan of given bubbling features; an obtaining module configured to obtain a plurality of bubbling features of a transportation plan of a user, wherein the plurality of bubbling features comprise (i) a bubble signal comprising time information and location information corresponding to the transportation plan, (ii) a supply and demand signal comprising transportation supply-demand information corresponding to the transportation plan, and (iii) transportation order history information of the user; a determining module configured to determine a discount signal based at least on feeding the plurality of bubbling features to the long-term value model; and a transmitting module configured to transmit the discount signal to a computing device of the user.

These and other features of the systems, methods, and non-transitory computer-readable media disclosed herein, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for purposes of illustration and description only and are not intended as a definition of the limits of the specification. It is to be understood that the foregoing general description and the following detailed description are exemplary and explanatory only, and are not restrictive of the specification, as claimed.

### BRIEF DESCRIPTION OF THE DRAWINGS

Non-limiting embodiments of the specification may be more readily understood by referring to the accompanying drawings in which:

FIG. 1A illustrates an exemplary system for machine learning and application, in accordance with various embodiments of the disclosure.

FIG. 1B illustrates an exemplary system for machine learning and application, in accordance with various embodiments of the disclosure.

FIG. 2A illustrates an exemplary policy workflow at a ride-hailing platform, in accordance with various embodiments of the disclosure.

FIG. 2B illustrates an exemplary flow of off-policy learning and an exemplary flow of online inference, in accordance with various embodiments.

FIG. 3A illustrates an exemplary model performance, in accordance with various embodiments.

FIG. 3B illustrates an exemplary model performance, in accordance with various embodiments.

FIG. 3C illustrates an exemplary model performance, in accordance with various embodiments.

FIG. 4 illustrates an exemplary method for machine learning and application, in accordance with various embodiments.

FIG. 5 illustrates an exemplary system for machine learning and application, in accordance with various embodiments.

FIG. 6 illustrates a block diagram of an exemplary computer system in which any of the embodiments described herein may be implemented.

### DETAILED DESCRIPTION

Non-limiting embodiments of the present specification will now be described with reference to the drawings. Particular features and aspects of any embodiment disclosed herein may be used and/or combined with particular features and aspects of any other embodiment disclosed herein. Such embodiments are by way of example and are merely illustrative of a small number of embodiments within the scope of the present specification. Various changes and modifications obvious to one skilled in the art to which the present specification pertains are deemed to be within the spirit, scope, and contemplation of the present specification as further defined in the appended claims.

In various embodiments, a user may log into a mobile phone APP or a website of an online ride-hailing platform and submit a request for transportation service—which can be referred to as bubbling. For example, a user may enter the starting and ending locations of a transportation trip through bubbling to receive an estimated price with or without an incentive such as a discount. Bubbling takes place before the acceptance and submission of an order of the transportation service. After receiving the estimated price (with or without a discount), the user may accept or reject the order. If the order is accepted and submitted, the online ride-hailing platform may match a vehicle with the submitted order.

The computing system of the online ride-hailing platform often needs user bubbling data to gauge the effects of various test policies. For example, the platform may need to know which incentive policy is more effective and accordingly implement a solution that can automatically make incentive decisions in real-time. However, it is practically impossible for human minds to evaluate these policies and make incentive decisions on the on-line platform scale. Moreover, non-machine learning methods in these areas are often inaccurate because of the many factors involved and their complicated unknown relations with the policy. Further, performing evaluations online in real-time is impractical because of its high cost and disruption to regular service. Thus, it is desirable to develop machine learning models based on transportation order bubbling behavior, which improves the function of the computing system of the online ride-hailing platform. The improvements may include, for example, (i) an increase in computing speed for model training because off-policy learning takes a much shorter time than real-time on-line testing, (ii) an improvement in data collection because real-time on-line testing can only output results under one set of conditions while the disclosed off-line training can generate results under different sets of conditions for the same subject, (iii) an increase in computing speed and accuracy for online incentive distribution because the trained model enables automatic decision making for thousands or millions of bubbling events in real-time, etc.

In some embodiments, the test policies may include a discount policy. When a user bubbles, the online ride-hailing platform may monitor the bubbling behavior in real-time and determine whether to push a discount to the user and which discount to push. The online ride-hailing platform may, by calling a model, select an appropriate discount or not offer any discount, and output the result to the user's device interface. A discount received by the user may encourage the passenger to proceed from bubbling to ordering (submitting the transportation order), which may be referred to as a conversion.

In some embodiments, in the long term, the discount policy may affect the user's bubble frequency over a long period (e.g., days, weeks, months). That is, the current bubble discount may stimulate the user to generate more bubbles in the future. It is, therefore, desirable to develop and implement policies that can, for each user, automatically make an incentive distribution decision at each bubbling event with the goal of maximizing the long term return (e.g., a difference between the growth of platform GMV (gross merchandise value) to the platform and cost of the incentives).

In some embodiments, Customer Relationship Management (CRM) focuses on optimizing strategies to maximize long-term passenger value. From a long-term perspective, the long-term value of passengers is largely determined by how often they bubble. Take the example of bubble scenarios in the online ride-hailing platform, conventional strategies aimed at optimizing the selection of discount on the bubble behaviors which happened already, and then using the static data to train the optimized policy. However, it does not take into account the influence of the discount on the future bubble frequency of the user. Thus, the conventional strategies are inaccurate for not accounting for the long-term impact.

To at least address the issues discussed above, in some embodiments, by formalizing user bubble sequences as a Markov Decision Process (MDP) trajectories, in some embodiments, the disclosure provides systems and methods to optimize the long-term value of user bubbling using a deep reinforcement learning Offline Deep-Q Network. The optimized policy model may be applied in real-time to the ride-hailing platform to execute decisions for each bubbling event.

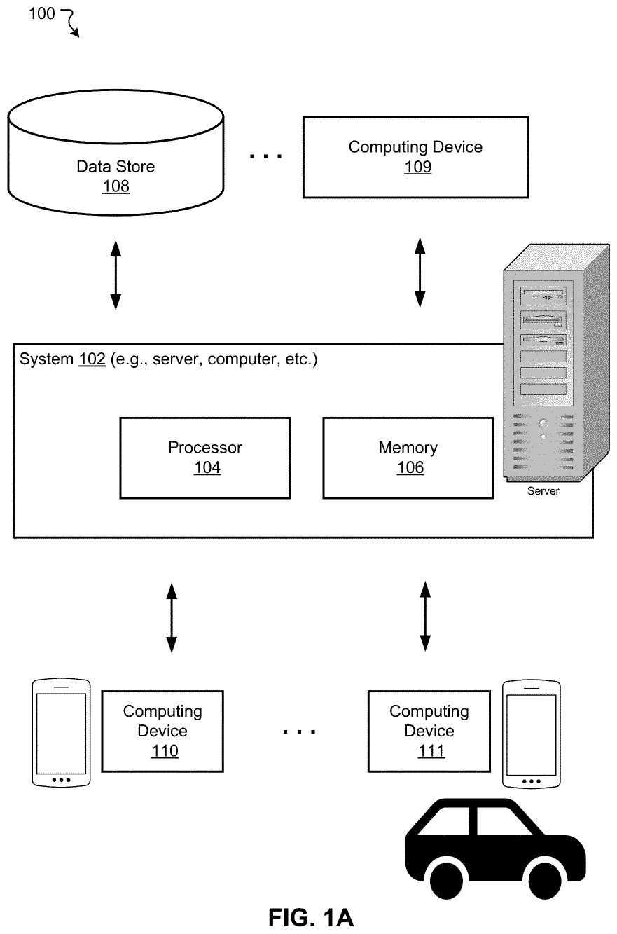

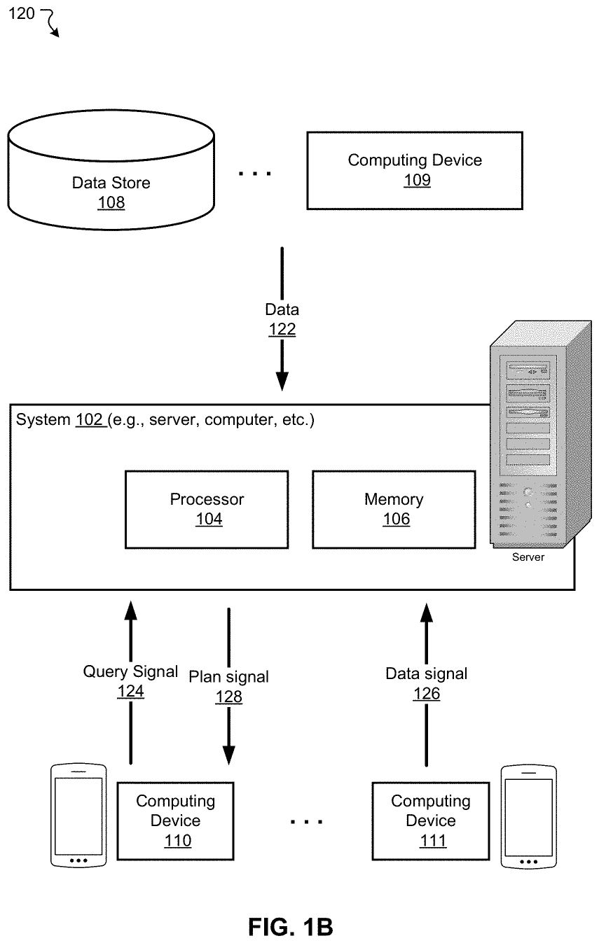

FIG. 1A illustrates an exemplary system 100 for machine learning and application, in accordance with various embodiments. The operations shown in FIG. 1A and presented below are intended to be illustrative. As shown in FIG. 1A, the exemplary system 100 may comprise at least one computing system 102 that includes one or more processors 104 and one or more memories 106. The memory 106 may be non-transitory and computer-readable. The memory 106 may store instructions that, when executed by the one or more processors 104, cause the one or more processors 104 to perform various operations described herein. The system 102 may be implemented on or as various devices such as mobile phones, tablets, servers, computers, wearable devices (smartwatches), etc. The system 102 above may be installed with appropriate software (e.g., platform program, etc.) and/or hardware (e.g., wires, wireless connections, etc.) to access other devices of the system 100.

The system 100 may include one or more data stores (e.g., a data store 108) and one or more computing devices (e.g., a computing device 109) that are accessible to the system 102. In some embodiments, the system 102 may be configured to obtain data (e.g., historical ride-hailing data such as location, time, and fees for multiple historical vehicle transportation trips) from the data store 108 (e.g., a database or dataset of historical transportation trips) and/or the computing device 109 (e.g., a computer, a server, or a mobile phone used by a driver or passenger that captures transportation trip information such as time, location, and fees). The system 102 may use the obtained data to train a machine learning model described herein. The location may be transmitted in the form of GPS (Global Positioning System) coordinates or other types of positioning signals. For example, a computing device (e.g., computing device 109 or 111) with GPS capability and installed on or otherwise disposed in a vehicle may transmit such location signal to another computing device (e.g., the system 102).

The system 100 may further include one or more computing devices (e.g., computing devices 110 and 111) coupled to the system 102. The computing devices 110 and 111 may include devices such as cellphones, tablets, in-vehicle computers, wearable devices (smartwatches), etc. The computing devices 110 and 111 may transmit signals (e.g., data signals) to or receive signals from the system 102.

In some embodiments, the system 102 may implement an online information or service platform. The service may be associated with vehicles (e.g., cars, bikes, boats, airplanes, etc.), and the platform may be referred to as a vehicle platform (alternatively as service hailing, ride-hailing, or ride order dispatching platform). The platform may accept requests for transportation service, identifying vehicles to fulfill the requests, arranging passenger pick-ups, and process transactions. For example, a user may use the computing device 110 (e.g., a mobile phone installed with a software application associated with the platform) to request a transportation trip arranged by the platform. The system 102 may receive the request and relay it to one or more computing device 111 (e.g., by posting the request to a software application installed on mobile phones carried by vehicle drivers or installed on in-vehicle computers). Each vehicle driver may use the computing device 111 to accept the posted transportation request and obtain pick-up location information. Fees (e.g., transportation fees) may be transacted among the system 102 and the computing devices 110 and 111 to collect trip payment and disburse driver income. Some platform data may be stored in the memory 106 or retrievable from the data store 108 and/or the computing devices 109, 110, and 111. For example, for each trip, the location of the origin and destination (e.g., transmitted by the computing device 110), the fee, and the time may be collected by the system 102.

In some embodiments, the system 102 and the one or more of the computing devices (e.g., the computing device 109) may be integrated in a single device or system. Alternatively, the system 102 and the one or more computing devices may operate as separate devices. The data store(s) may be anywhere accessible to the system 102, for example, in the memory 106, in the computing device 109, in another device (e.g., network storage device) coupled to the system 102, or another storage location (e.g., cloud-based storage system, network file system, etc.), etc. Although the system 102 and the computing device 109 are shown as single components in this figure, it is appreciated that the system 102 and the computing device 109 can be implemented as a single device or multiple devices coupled together. The system 102 may be implemented as a single system or multiple systems coupled to each other. In general, the system 102, the computing device 109, the data store 108, and the computing device 110 and 111 may be able to communicate with one another through one or more wired or wireless networks (e.g., the Internet) through which data can be communicated.

FIG. 1B illustrates an exemplary system 120 for machine learning and application, in accordance with various embodiments. The operations shown in FIG. 1B and presented below are intended to be illustrative. In various embodiments, the system 102 may obtain data 122 (e.g., historical data) from the data store 108 and/or the computing device 109. The historical data may comprise, for example, historical transportation trips and corresponding data including bubbling data (e.g., bubbling time, bubbling origin, bubbling destination, quoted price, discount), transportation data (e.g., trip time, trip origin, trip destination, paid price), etc. Some of the historical data may be used as training data for training models. The obtained data 122 may be stored in the memory 106. The system 102 may train a machine learning model with the obtained data 122.

In some embodiments, the computing device 110 may transmit a signal (e.g., query signal 124) to the system 102. The computing device 110 may be associated with a passenger seeking transportation service. The query signal 124 may correspond to a bubble signal comprising information such as a current location of the passenger, a current time, an origin of a planned transportation, a destination of the planned transportation, etc. In the meanwhile, the system 102 may have been collecting data (e.g., data signal 126) from each of a plurality of computing devices such as the computing device 111. The computing device 111 may be associated with a driver of a vehicle described herein (e.g., taxi, a service-hailing vehicle). The data signal 126 may correspond to a supply signal of a vehicle available for providing transportation service.

In some embodiments, the system 102 may obtain a plurality of bubbling features of a transportation plan of a user. For example, bubbling features of a user bubble may include (i) a bubble signal comprising a timestamp, an origin location of the transportation plan of the user, a destination location of the transportation plan, a route departing from the origin location and arriving at the destination location, a vehicle travel duration along the route, and/or a price quote corresponding to the transportation plan, (ii) a supply and demand signal comprising a number of passenger-seeking vehicles around the origin location, and a number of vehicle-seeking transportation orders departing from the origin location, and (iii) a transportation order history signal of the user. Some information of the bubble signal may be collected from the query signal 124 and/or other sources such as the data stores 108 and the computing device 109 (e.g., the timestamp may be obtained from the computing device 109) and/or generated by the system 102 (e.g., the route may be generated at the system 102). The supply and demand signal may be collected from the query signal of a computing device of each of multiple users and the data signal of a computing device of each of multiple vehicles. The transportation order history signal may be collected from the computing device 110 and/or the data store 108. In one embodiment, the vehicle may be an autonomous vehicle, and the data signal 128 may be collected from an in-vehicle computer.

In some embodiments, when making the assignment, the system 102 may send a plan (e.g., plan signal 128) to the computing device 110 or one or more other devices. The plan signal 128 may include a price quote, a discount signal, the route departing from the origin location and arriving at the destination location, an estimated time of arrival at the destination location, etc. The plan signal may be presented on the computing device 110 for the user to accept or reject. From the platform's perspective, the query signal 124, the data signal 126, and the plan signal 128 may be found in a policy workflow 200 described below.

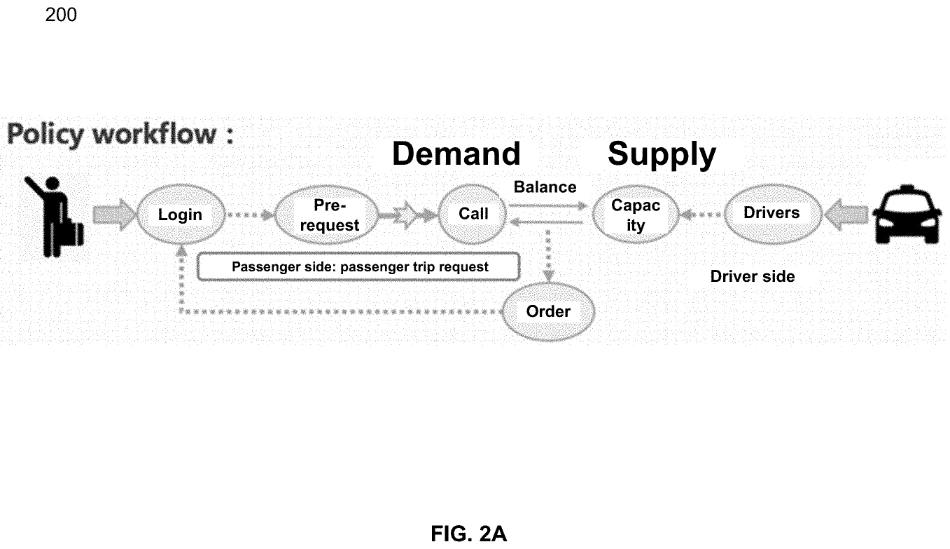

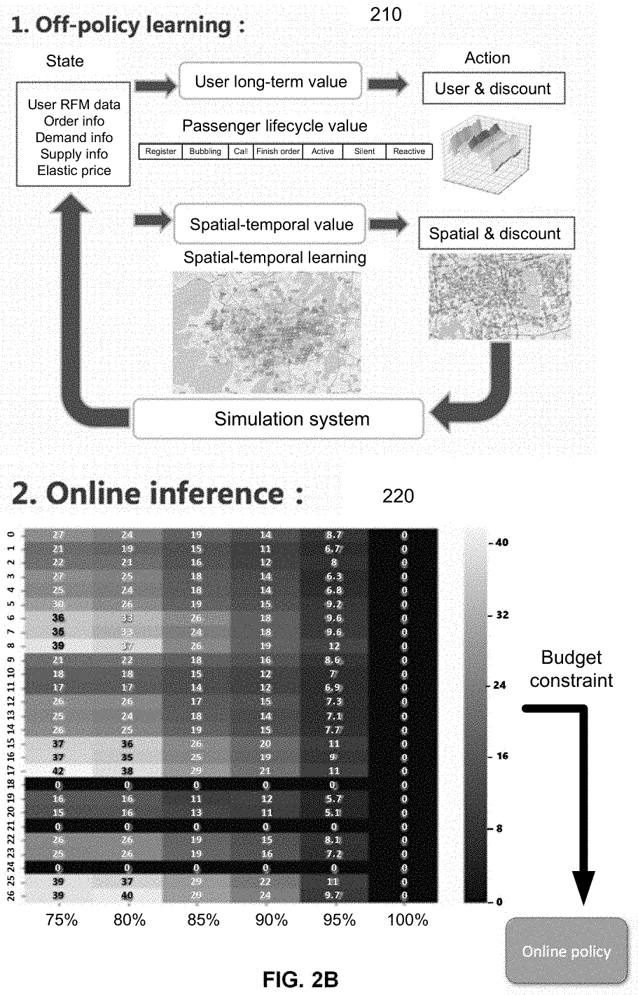

FIG. 2A illustrates an exemplary policy workflow 200 at a ride-hailing platform, in accordance with various embodiments of the disclosure. The policy workflow 200 may be implemented by, for example, the system 100 of FIG. 1A and FIG. 1B. For example, a non-transitory computer-readable storage medium (e.g., the memory 106) may store instructions that, when executed by a processor (e.g., the processor 104), cause the system 102 (e.g., the processor 104) to perform the policy workflow 200. The operations of the policy workflow 200 presented below are intended to be illustrative. Depending on the implementation, the exemplary method 200 may include additional, fewer, or alternative steps performed in various orders or in parallel.

In some embodiments, the platform may monitor the supply side (supply of transportation service). For example, through the collection of the data signal 126 described above, the platform may acquire information of available vehicles for providing transportation service at different locations and at different times.

In some embodiments, through an online ride-hailing product interface (e.g., an APP installed on a mobile phone), a user may log in and enter an origin location and a destination location of a planned transportation trip in a pre-request for transportation service. When submitted, the pre-request becomes a call for the transportation service received by the platform. The query signal 124 may include the call, which may also be referred to as a bubbling event or bubble for short at the demand side (demand for transportation service).

In some embodiments, when receiving the call, the platform may search for a vehicle for providing the requested transportation. Further, the platform may manage an intelligent subsidy program, which can monitor the user's bubble behavior in real-time, select an appropriate discount (e.g., 10% off, 20% off, no discount) by calling a machine learning model and send it to the user's bubble interface timely along with a quoted price for the transportation in the plan signal 128. After receiving the quoted price and the discount, the user may be incentivized to accept the transportation order, thus completing the conversion from bubbling to order.

In some embodiments, in the long run, the intelligent subsidy program may affect each user's bubbling frequency over a long period. That is, the current bubble discount may incentivize the user to generate more bubbles in the future. For example, during high supply and low demand hours such as 10 am to 2 pm on workdays, providing discounts may invite more ride-hailing bubbling events and thus even the gap between supply and demand. From a long-term perspective, direct optimization to increase the long-term value of users will be more conducive to promoting the growth of the platform's GMV.

FIG. 2B illustrates an exemplary flow of off-policy learning 210 and an exemplary flow of online inference 220, in accordance with various embodiments. The off-policy learning 210 and the online inference 220 may be implemented by, for example, the system 100 of FIG. 1A and FIG. 1B. For example, a non-transitory computer-readable storage medium (e.g., the memory 106) may store instructions that, when executed by a processor (e.g., the processor 104), cause the system 102 (e.g., the processor 104) to perform the off-policy learning 210 and the online inference 220. The operations of the off-policy learning 210 and the online inference 220 presented below are intended to be illustrative. Depending on the implementation, the off-policy learning 210 and the online inference 220 may include additional, fewer, or alternative steps performed in various orders or in parallel.

The off-policy learning 210 in FIG. 2B refers to a model training stage. In some embodiments, one or more computing devices may collect historical user bubbling events corresponding to historical users bubbling at different historical times, and formulate historical user bubbling events of each of the historical users into a Markov Decision Process (MDP) trajectory to obtain the plurality of series of temporally-sequenced user bubbling events.

In some embodiments, to produce training data for Reinforcement Learning (RL), each user bubble sequence (the sequence of bubbling events of each user) may be represented by a Markov Decision Processes (MDP) quintuple (S, A, T, R, γ). In another word, the MDP trajectory includes a quintuple (S, A, T, R, γ), where S represents a state space comprising a plurality of states corresponding to the bubbling features of the historical users, A represents an action space comprising a plurality of actions corresponding to the historical discount strategies applied to the historical users, T: S×A [symbol] S represents a state transition model based on S and A (an agent of RL at a state takes an action transits to a next state, and the process of which is the transition T), R: S×A [symbol] [symbol] represents a reward function based on S and A (the reward corresponds to the transition T), and γ represents a discount factor of a cumulative reward.

In some embodiments, reinforcement learning aims to optimize a policy π that determines the action to take at a certain state π [symbol] A to maximize the expected γ-discounted cumulative reward J, denoted as

j(π)=E_{π}[Σₜ₌₀^{T}γ^{t}rₜ],

by enabling agents to learn from interactions with the environment. The agent observes state s from the environment, selects action α given by π to execute in the environment and then observes the next state, obtains the reward r at the same time until a terminal state is reached. Consequently, the goal of RL is to find the optimal policy π of the platform, denoted as

π*=arg max_{π}E_{π}[Σₜ₌₀^{T}γ^{t}rₜ],

that maximizes the expected cumulative reward.

In some embodiments, to optimize the long-term value of the user, each user's bubble sequence may be modeled as an MDP trajectory, in which each bubble-discount pair (e.g., bubbling features of each bubbling event and provided discount) is defined as a step of RL. Detailed definitions of an MDP model are as follows:

State: Bubbling features of the bubbling event such as trip distance, GMV, estimated duration, and real-time supply and demand characteristics of the starting and ending points, the user's frequency of use, information of the locale, weather condition, etc.

Action: N+1 discrete actions including N kinds of discounts and no discount.

Reward: The expected uplift value of the bubbling by the current discount. The reward may depend on whether the bubbling user converted the bubbling to ordering and how much the user eventually paid for the order. The reward r may be represented by a product between (i) AECR the increase in the user's probability of converting from bubbling to ordering and (ii) GMV the estimated price of the current bubble trip.

r=ΔECR*GMV

where ΔECR=ECRₐ−ECRₐ₀
ECRₐ₀=probability of ordering when no discount is given/probability of bubble
ECRₐ=probability of ordering when discount is given/probability of bubble
ECRₐ may be directly found in historical data, ECRₐ₀ that corresponds to the ECRₐ of the same bubbling event may be obtained by historical data fitting (historical transition).

State transition dynamics: Based on historical data, bubbling features of the next bubbling event of the user are directly sampled as the next state. Sᵢ₊₁=T(sᵢ, aᵢ).

Discounted factor: The discounted factor of the cumulative reward. For example, it may be set to be 0.9.

That is, in some embodiments, training the machine learning model includes: enabling a reinforcement learning agent to, until reaching a terminal state, learn from interactions with a reinforcement learning environment, wherein the reinforcement learning agent is configured to observe a state s from the environment, select an action a given by a policy π to execute in the environment, and then observe a next state s+1 and obtain a reward r corresponding to the state transition from s to s+1 with the action a, wherein the policy π is based at least on one or more weights and/or one or more biases; and optimizing the policy π based at least on tuning the one or more weights and/or the one or more biases. The state s corresponds to a historical bubbling event; the action a corresponds to a historical discount signal; and the reward r is based at least on a product between (i) a price of a historical transportation completed from the historical bubbling event and (ii) a change between a first conversion rate of conversion from a bubbling event to a transportation order with discount and a second conversion rate of conversion from a bubbling event to a transportation order without discount. The plurality of actions include a number (N) of discrete discounts and no discount. The action corresponding to the historical discount signal includes information of the historical discount offered with respect to the transportation order with discount. The transportation order without discount may be simulated from historical data through data fitting.

Details of the deep RL framework are described with reference to FIG. 2A and FIG. 2B. In some embodiments, one or more computing devices may train a machine learning model (e.g., RL model, MDP model) with training data to obtain a long-term value model. The training data may include a plurality of series of temporally-sequenced user bubbling events (e.g., user A's bubbling event 1 at timestamp 1, user A's bubbling event 2 at timestamp 2, etc.). Each bubbling event may include bubbling features described in this application (e.g., a bubble signal comprising time information and location information corresponding to the transportation plan, a supply and demand signal comprising transportation supply-demand information corresponding to the transportation plan, transportation order history information of the user). Each of the user bubbling events may correspond to a historical transportation query from a user device and a historical response including a historical discount signal from a server (e.g., no discount offered for user A's bubbling event 1, 50% off discount offered for user A's bubbling event 2, etc.). When deployed to the platform, the long-term value model may be configured to automatically perform discount signal determination for thousands or millions of users in real-time based on given bubbling features of these users.

In some embodiments, based on the MDP model defined above, a Deep-Q Network (DQN) algorithm and its variants may be used to train a state-action value function by using the historical data. The learned function may be used as a long-term value function for making decisions on dispensing subsidy discounts with the goal of optimizing the long-term user value. Thus, the MDP model may also be referred to as a long-term value model.

In some embodiments, offline deep Q-learning with experience replace may be used to train the long-term value function. Since online learning of the policy in the real-world environment is impractical, an offline deep Q-learning approach may be adopted for training an offline DQN based on on the historical data.

In some embodiments, by experience replay, historical interactions between users and the platform at each time-step eₜ=(sₜ, aₜ, rₜ, sₜ₊₁) may be stored in a dataset [symbol] ={e₁, . . . e_{N}}, pooled over many episodes into a replay memory (or referred to as a replay buffer). Then, for the MDP model, the observed transitions may be used to replace the interaction with the environment. The transitions may be sampled in mini-batch from the replay memory to fit the state-action value function. In this way, a reliable Q-function model may be learned based on the offline observed data.

In some embodiments, in the Q-learning updates, differentiating the loss function with respect to the model weights gives the following gradient:

$${∇}_{{θ}_{i}} {L}_{i} ( {θ}_{i} ) = {𝔼}_{s , a ; {s}^{′} ∼ ε} [ ( r + {γmax}_{{a}^{′}} Q ( {s}^{′} , {a}^{′} ; {θ}_{i - 1} ) - Q ( s , a ; {θ}_{i} ) ) {∇}_{{θ}_{i}} Q ( s , a ; {θ}_{i} ) ]$$

In some embodiments, the parameters from the previous iteration θᵢ₋₁ are held fixed when optimizing the loss function Lᵢ(θᵢ).

In some embodiments, the training process of the Offline DQN is provided in Algorithm 1 below. First, a warm-up operation may be performed to fill the replay memory with some transitions, which may make a stable start of the training process. Then, during the loop of the algorithm, Q-learning updates or minibatch updates may be applied to samples of experience (e˜ [symbol] ) drawn at random from the pool of stored transitions. Learning directly from consecutive samples may be inefficient due to the strong correlations between the samples. Thus, randomizing the samples breaks these correlations and therefore reduces the variance of the updates.

Algorithm 1: Offline Deep Q-learning with Experience Replay

| | |
|---|---|
| 1 | Initialize replay memory [symbol] to capacity N; |
| 2 | Initialize action-value function Q with random weights. |
| 3 | Store some historical transitions (sᵢ, aᵢ, rᵢ, sᵢ₊₁) in [symbol] as a warm-up |
| | step. |
| 4 | for episode = 1, M do |
| 5 | Randomly sample a transition eₜ = (sₜ, aₜ, rₜ, sₜ₊₁) from the historical |
| | dataset. |
| 6 | Store transition eₜ in [symbol] . |
| 7 | Sample random minibatch of transitions (sⱼ, aⱼ, rⱼ, sⱼ₊₁) from [symbol] . |
| 8 | $Set {y}_{j} = \{ \begin{matrix}{r}_{j} & for terminal state {s}_{j + 1} \\ {r}_{j} + γ {max}_{{a}^{′}} Q ( {s}_{j + 1} , {a}^{′} ; θ ) & for non - terminal state {s}_{j + 1}\end{matrix}$ |
| 9 | Perform a gradient descent step on (yⱼ − Q(sⱼ, aⱼ; θ))² to minimize |
| | the loss. |
| 10 | end for |

In various embodiments, three extensions (double Q-learning, prioritized replay, dueling networks) to the Offline DQN may be applied to improve its performance. A single integrated agent integrated with all of the three components may be referred to as Offline Rainbow.

In some embodiments, double Q-learning may be used. Optimizing the policy it of the model may include applying a double-Q learning algorithm configured to maximize an expectation of the cumulative reward subject to the discount y and optimize the selection of the action a from the plurality of actions of the action space. Conventional Q-learning may be affected by an overestimation bias, due to the maximization step in Q-learning updates, and this may harm learning. Double Q-learning addresses this overestimation by decoupling the selection of the action from its evaluation in the maximization performed for the bootstrap target. In one embodiment, double Q-learning may be efficiently combined with the Offline DQN, using the loss

(Rₜ₊₁+γₜ₊₁Q_{θ′}(Sₜ₊₁, argmax_{α′}Q_{θ}(Sₜ₊₁, α′))−Q_{θ}(Sₜ, Aₜ))²

The use of double Q-learning here reduces harmful overestimations that are present in DQN, thereby improving the performance of the model.

In some embodiments, prioritized replay may be adopted to process training data. DQN samples uniformly from the replay buffer. However, transitions with high expected learning progress, as measured by the magnitude of their TD error, need to be sampled more frequently. To this end, as a proxy for learning potential, prioritized experience replay may be applied to sample transitions with probability pₜ relative to the last encountered absolute TD error:

$${p}_{t} ∝ {\vert {R}_{t + 1} + {γ}_{t + 1} {max}_{{a}^{′}} {Q}_{{θ}^{′}} ( {S}_{t + 1} , {a}^{′} ) - {Q}_{θ} ( {S}_{t} , {A}_{t} ) \vert}^{w}$$

where w is a hyper-parameter that determines the shape of the distribution. New transitions may be inserted into the replay buffer with maximum priority, providing a bias towards recent transitions so they may be sampled more frequently. Further, stochastic transitions (e.g., transitions randomly selected by an algorithm from the replay memory) may also be favored, even when there is little left to learn about them. As described above, the historical user bubbling events respectively correspond to transitions in reinforcement learning. To process the training data, the one or more computing devices may assign greater weights to transitions with greater temporal difference (TD) errors, more recent transitions, and/or stochastic transitions. Then, for training, the one or more computing devices may randomly sample the transitions from the training data according to the assigned weights.

In some embodiments, dueling networks may be adopted. The dueling network is a neural network architecture designed for value-based RL. It features two streams of computation, the value stream (first stream) and the advantage stream (second stream), sharing a representation encoder, and merged by a special aggregator. This corresponds to the following factorization of action values:

$${Q}_{θ} ( s , a ) = {V}_{η} ( {f}_{ξ} ( s ) ) + {A}_{ψ} ( {f}_{ξ} ( s ) , a ) - \frac{{Σ}_{{a}^{′}} {A}_{ψ} ( {f}_{ξ} ( s ) , {a}^{′} )}{{N}_{actions}}$$

where ξ, η, and ψ are, respectively, the parameters of the shared encoder f_{ξ}, the parameters of the value stream V_{η}, and the parameters of the advantage stream A_{ψ}, and θ={ξ, η, ψ}is their concatenation. N_{actions} refers to a number of the actions. Further, A_{θ}(s, α)=Q_{θ}(s,α)−V(s), where Q_{θ}(s, α) represents the value function for the state s and action α and V(s) represents the value function of state s regardless of action α. Thus, A_{θ}(s, α) represents the advantage of executing action α over execution without action α when the state is s. That is, the machine learning model may include a representation encoder, a dueling network, and an aggregator, where the dueling network may include a first stream and a second stream configured to share the encoder and outcouple to the aggregator, the first stream is configured to estimate the reward r corresponding to the state s and the action a, and the second stream is configured to estimate a difference between the reward r and an average.

Online inference 220 refers to the online deployment of an online policy and application stage. In some embodiments, by training, the long-term value model is configured to generate a value matrix that maps to combinations of different users and different discount signals. Online inference 220 shows the matrix that maps long-term Q values (Q(s, a)) to various combinations of user (0, 1, 2, . . . on the y-axis) and price quote (75% of the original price, 80% of the original price, . . . on the x-axis). For example, for user 1, if offering 75% of the original price as the quote, the long-term Q value is 27, whereas if offering no discount (100% of the original price) to user 1, the long-term Q value is 0. When online policy deployed is deployed, the long-term value model is configured to, for each user, predict long-term values for respectively applying different discount signals to a given transportation plan of given bubbling features, in order to optimize a long-term return to the ride-hailing platform and comply with a budget constraint. The determination may be performed simultaneously in real-time for many users on a large scale without human intervention, subject to a budget constraint of the platform.

In some embodiments, for example, the one or more computing devices may obtain a plurality of bubbling features of a transportation plan of a user. These bubbling features may be included in the bubbling events of historical data used for model training. The plurality of bubbling features may include (i) a bubble signal comprising time information and location information corresponding to the transportation plan, (ii) a supply and demand signal comprising transportation supply-demand information corresponding to the transportation plan, and (iii) transportation order history information of the user. In one embodiment, the location information includes an origin location of the transportation plan of the user, a destination location of the transportation plan, a distance between the origin location and the destination location, and a route departing from the origin location and arriving at the destination location; the time information includes a timestamp, and a vehicle travel duration along the route; and the transportation supply-demand information includes a number of passenger-seeking vehicles around the origin location and a number of vehicle-seeking transportation orders departing from the origin location.

In some embodiments, the origin location of the transportation plan of the user includes a geographical positioning signal of the computing device of the user; and obtaining the supply and demand signal includes: obtaining, from a plurality of computing devices of a plurality of vehicle drivers, a plurality of geographical positioning signals respectively corresponding to the plurality of computing devices of the plurality vehicle drivers; and determining the number of passenger-seeking vehicles around the origin based on the plurality of geographical positioning signals and the geographical positioning signal of the computing device of the user. In one embodiment, the geographical positioning signal comprises a GPS signal; and the plurality of geographical positioning signals include a plurality of GPS signals. In some embodiments, the location information further includes one or more of the following: a weather condition at one or more locations along the route; and a traffic condition at one or more locations along the route. In some embodiments, the bubble signal further includes a price quote corresponding to the transportation plan; and the method further comprises presenting, by the computing device of the user, the discount signal, the route, and the price quote.

In some embodiments, the transportation order history information of the user includes one or more of the following: a frequency of order transportation order bubbling by the user; a frequency of transportation order completion by the user; a history of discount offers provided to the user in response to the order transportation order bubbling; and a history of responses of the user to the discount offers.

The bubble signal, the supply and demand signal, and the transportation order history information may all affect the long-term value for currently offering an incentive to the user. Thus, they were used in training data for training the machine learning model, and in the online application, they are collected from real-time users as inputs for executing the online policy.

In some embodiments, the one or more computing devices may determine a discount signal based at least on feeding the plurality of bubbling features to the long-term value model, and transmit the discount signal to a computing device of the user. In some embodiments, the one or more computing devices may receive, from the computing device of the user, an acceptance signal comprising an acceptance of the transportation plan of the user, the price quote, and a price discount corresponding to the discount signal; and transmit the transportation plan to a computing device of a vehicle driver for fulfilling the transportation order.

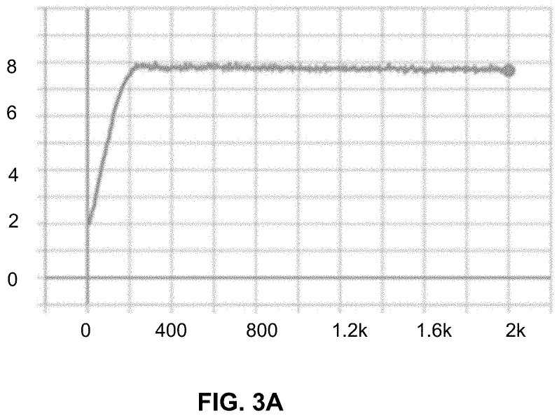

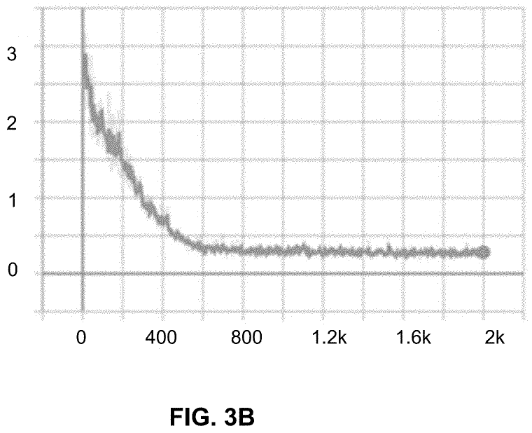

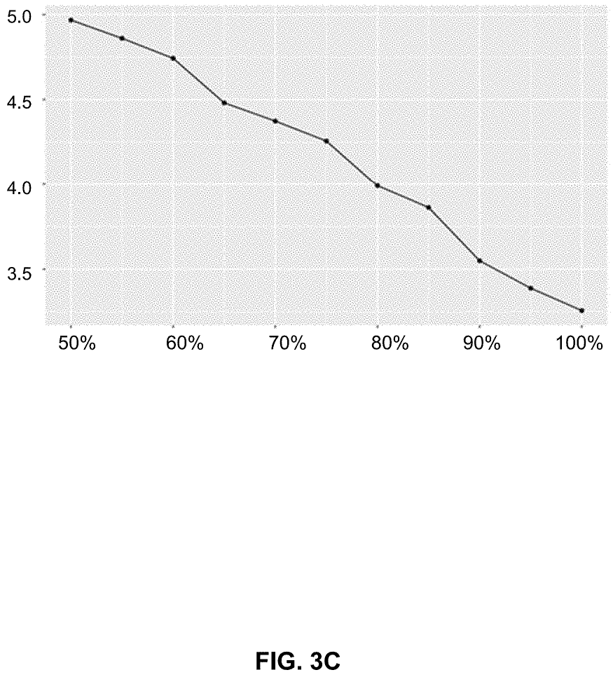

FIG. 3A illustrates an exemplary model performance, in accordance with various embodiments. FIG. 3B illustrates an exemplary model performance, in accordance with various embodiments. The operations shown in FIG. 3A, FIG. 3B, and presented below are intended to be illustrative.

In some embodiments, the Offline Rainbow may be applied to the application of determining passenger trip request incentives. A stable long-term value function model is obtained by training based on historical data. The effectiveness of the model training may be verified according to three aspects: learning curves during model training, offline simulation results evaluation, and online experiment results evaluation.

In some embodiments, for learning curve during model training, FIG. 3A shows the learning curve of mean Q value with respect to training rounds, and FIG. 3B shows the loss during the training process with respect to training rounds. As shown, Offline Rainbow method converges to a reasonable Q value smoothly and quickly.

FIG. 3C illustrates an exemplary model performance, in accordance with various embodiments. The operations shown in FIG. 3C and presented below are intended to be illustrative. In some embodiments, for offline simulation results evaluation, FIG. 3C shows the expected long-term value of different discounts predicted by the learned model. On the x-axis, 60% means a 40% off discount, and 100% means no discount. As the discount level intensifies, the corresponding long-term value increases, which is consistent with business expectations and real-world physical implications.

In some embodiments, for online experiment results evaluation, the learned long-term value (LTV) model is deployed to the online system of the platform, and an A/B experiment is performed with an existing subsidy policy model STV model for 152 cities. Table 1 below shows the results that the an algorithm effectiveness indicator ROI of the LTV model is significantly improved compared with the STV model (baseline) under the condition of consistent subsidy rate, which demonstrates the effectiveness of the disclosed Offline Rainbow method and shows the importance of optimizing long-term value for such subsidy tasks. ROI measures the effectiveness of the algorithm. When ROI is higher, it means that the model is more efficient. In one embodiment, ROI is equal to (GMV_target model—GMV_control model)/(Cost_target model—Cost_control model).

TABLE 1
Online A/B experiment results: LTV-mode and STV-model

| | ROI | | delta | Subsidy Rate | |
|---|---|---|---|---|---|
| Period | LTV-model | STV-model | ROI | LTV-model | STV-model |
| 20200406-20200419 | 1.113 | 1.056 | 6.50% | 2.84% | 2.34% |
| 20200426-20200504 | 0.916 | 0.858 | 6.70% | 4.48% | 3.63% |
| 20200623-20200626 | 1.223 | 1.133 | 7.90% | 1.51% | 1.36% |

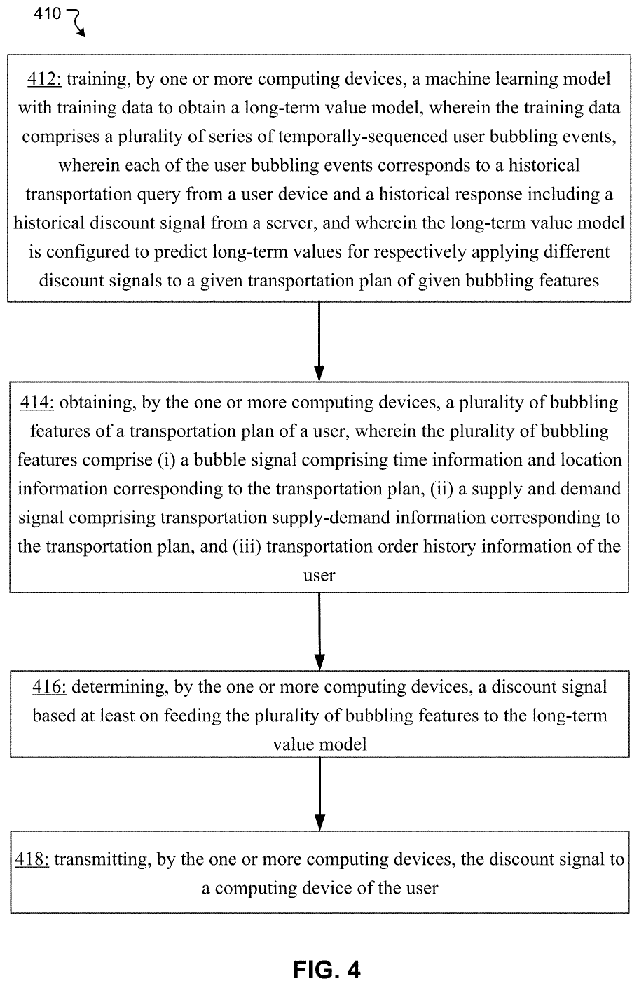

FIG. 4 illustrates a flowchart of an exemplary method 410 for machine learning and application, according to various embodiments of the present disclosure. The method 410 may be implemented in various environments including, for example, by the system 100 of FIG. 1A and FIG. 1B. The exemplary method 410 may be implemented by one or more components of the system 102. For example, a non-transitory computer-readable storage medium (e.g., the memory 106) may store instructions that, when executed by a processor (e.g., the processor 104), cause the system 102 (e.g., the processor 104) to perform the method 410. The operations of method 410 presented below are intended to be illustrative. Depending on the implementation, the exemplary method 410 may include additional, fewer, or alternative steps performed in various orders or in parallel.

Block 412 includes training, by one or more computing devices, a machine learning model with training data to obtain a long-term value model, wherein the training data comprises a plurality of series of temporally-sequenced user bubbling events, wherein each of the user bubbling events corresponds to a historical transportation query from a user device and a historical response including a historical discount signal from a server, and wherein the long-term value model is configured to predict long-term values for respectively applying different discount signals to a given transportation plan of given bubbling features.

In some embodiments, before the step 412, the method 410 further includes: collecting, by the one or more computing devices, historical user bubbling events corresponding to the historical users bubbling at different historical times; and formulating, by the one or more computing devices, historical user bubbling events of each of the historical users into a Markov Decision Process (MDP) trajectory to obtain the plurality of series of temporally-sequenced user bubbling events.

In some embodiments, the historical user bubbling events respectively correspond to transitions in reinforcement learning; the method further comprises assigning greater weights to transitions with greater temporal difference (TD) errors, more recent transitions, and/or stochastic transitions; and training the machine learning model with training data comprises randomly sampling the transitions from the training data according to the assigned weights.

In some embodiments, the MDP trajectory comprises a quintuple (S, A, T, R, γ); S represents a state space comprising a plurality of states corresponding to the bubbling features of the historical users; A represents an action space comprising a plurality of actions corresponding to the historical discount strategies applied to the historical users; T represents a state transition model based on S and A; R represents a reward function based on S and A; and γ represents a discount factor of a cumulative reward.

In some embodiments, training the machine learning model comprises: enabling a reinforcement learning agent to, until reaching a terminal state, learn from interactions with a reinforcement learning environment, wherein the reinforcement learning agent is configured to observe a state s from the environment, select an action α given by a policy π to execute in the environment, and then observe a next state s+1 and obtain a reward r corresponding to the state transition from s to s+1 with the action α, wherein the policy π is based at least on one or more weights and/or one or more biases; and optimizing the policy π based at least on tuning the one or more weights and/or the one or more biases.

In some embodiments, the state s corresponds to a historical bubbling event; the action α corresponds to a historical discount signal; and the reward r is based at least on a product between (i) a price of a historical transportation completed from the historical bubbling event and (ii) a change between a first conversion rate of conversion from a bubbling event to a transportation order with discount and a second conversion rate of conversion from a bubbling event to a transportation order without discount.

In some embodiments, the plurality of actions comprise: a number (N) of discrete discounts and no discount.

In some embodiments, optimizing the policy π comprises: applying a double-Q learning algorithm configured to maximize an expectation of the cumulative reward subject to the discount γ and optimize the selection of the action α from the plurality of actions of the action space.

In some embodiments, the machine learning model comprises a representation encoder, a dueling network, and an aggregator; the dueling network comprises a first stream and a second stream configured to share the encoder and outcouple to the aggregator; the first stream is configured to estimate the reward r corresponding to the state s and the action α; and the second stream is configured to estimate a difference between the reward r and an average.

In some embodiments, the long-term value model is configured to: generate a value matrix that maps to combinations of different users and different discount signals; and automatically perform discount signal determination based on the given bubbling features and the value matrix to optimize a long-term return to the ride-hailing platform and comply with a budget constraint.

Block 414 includes obtaining, by the one or more computing devices, a plurality of bubbling features of a transportation plan of a user, wherein the plurality of bubbling features comprise (i) a bubble signal comprising time information and location information corresponding to the transportation plan, (ii) a supply and demand signal comprising transportation supply-demand information corresponding to the transportation plan, and (iii) transportation order history information of the user.

In some embodiments, the location information comprises an origin location of the transportation plan of the user, a destination location of the transportation plan, a distance between the origin location and the destination location, and a route departing from the origin location and arriving at the destination location; the time information comprises a timestamp, and a vehicle travel duration along the route; and the transportation supply-demand information comprises a number of passenger-seeking vehicles around the origin location and a number of vehicle-seeking transportation orders departing from the origin location.

In some embodiments, the origin location of the transportation plan of the user comprises a geographical positioning signal of the computing device of the user; and obtaining the supply and demand signal comprises: obtaining, from a plurality of computing devices of a plurality of vehicle drivers, a plurality of geographical positioning signals respectively corresponding to the plurality of computing devices of the plurality vehicle drivers; and determining the number of passenger-seeking vehicles around the origin based on the plurality of geographical positioning signals and the geographical positioning signal of the computing device of the user.

In some embodiments, the geographical positioning signal comprises a Global Positioning System (GPS) signal; and the plurality of geographical positioning signals comprise a plurality of GPS signals.

In some embodiments, the location information further comprises one or more of the following: a weather condition at one or more locations along the route; and a traffic condition at one or more locations along the route.

In some embodiments, the bubble signal further comprises a price quote corresponding to the transportation plan; and the method further comprises presenting, by the computing device of the user, the discount signal, the route, and the price quote.

In some embodiments, the transportation order history information of the user comprises one or more of the following: a frequency of order transportation order bubbling by the user; a frequency of transportation order completion by the user; a history of discount offers provided to the user in response to the order transportation order bubbling; and a history of responses of the user to the discount offers.

Block 416 includes determining, by the one or more computing devices, a discount signal based at least on feeding the plurality of bubbling features to the long-term value model.

Block 418 includes transmitting, by the one or more computing devices, the discount signal to a computing device of the user.

In some embodiments, the method further comprises: receiving, by the one or more computing devices, from the computing device of the user, an acceptance signal comprising an acceptance of the transportation plan of the user, the price quote, and a price discount corresponding to the discount signal; and transmitting, by the one or more computing devices, the transportation plan to a computing device of a vehicle driver for fulfilling the transportation order.

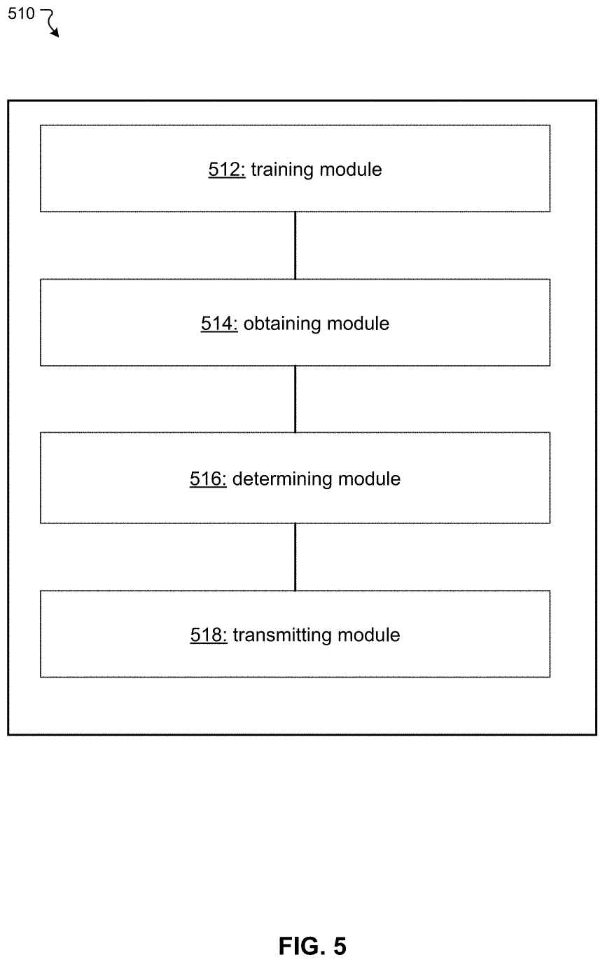

FIG. 5 illustrates a block diagram of an exemplary computer system 510 for machine learning and application, in accordance with various embodiments. The system 510 may be an exemplary implementation of the system 102 of FIG. 1A and FIG. 1B or one or more similar devices. The method 410 may be implemented by the computer system 510. The computer system 510 may include one or more processors and one or more non-transitory computer-readable storage media (e.g., one or more memories) coupled to the one or more processors and configured with instructions executable by the one or more processors to cause the system or device (e.g., the processor) to perform the method 410. The computer system 510 may include various units/modules corresponding to the instructions (e.g., software instructions). In some embodiments, the instructions may be implemented as a computer program product (e.g., software) such as a desktop software or an application (APP) installed on a mobile phone, pad, etc.

In some embodiments, the computer system 510 may include a training module 512 configured to train a machine learning model with training data to obtain a long-term value model, wherein the training data comprises a plurality of series of temporally-sequenced user bubbling events, wherein each of the user bubbling events corresponds to a historical transportation query from a user device and a historical response including a historical discount signal from a server, and wherein the long-term value model is configured to predict long-term values for respectively applying different discount signals to a given transportation plan of given bubbling features; an obtaining module 514 configured to obtain a plurality of bubbling features of a transportation plan of a user, wherein the plurality of bubbling features comprise (i) a bubble signal comprising time information and location information corresponding to the transportation plan, (ii) a supply and demand signal comprising transportation supply-demand information corresponding to the transportation plan, and (iii) transportation order history information of the user; a determining module 516 configured to determine a discount signal based at least on feeding the plurality of bubbling features to the long-term value model; and a transmitting module 518 configured to transmit the discount signal to a computing device of the user.

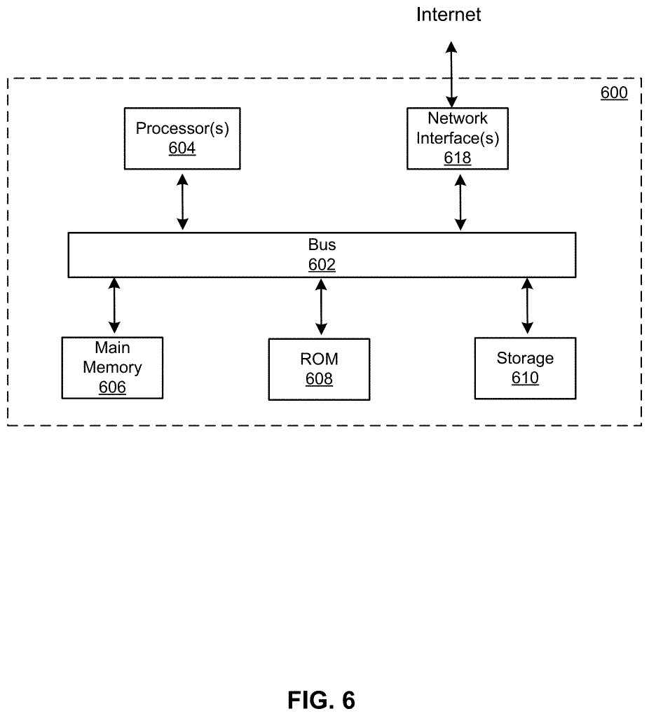

FIG. 6 is a block diagram that illustrates a computer system 600 upon which any of the embodiments described herein may be implemented. The system 600 may correspond to the system 102 or the computing device 109, 110, or 111 described above. The computer system 600 includes a bus 602 or another communication mechanism for communicating information, one or more hardware processors 604 coupled with bus 602 for processing information. Hardware processor(s) 604 may be, for example, one or more general-purpose microprocessors.

The computer system 600 also includes a main memory 606, such as a random access memory (RAM), cache, and/or other dynamic storage devices, coupled to bus 602 for storing information and instructions to be executed by processor 604. Main memory 606 also may be used for storing temporary variables or other intermediate information during execution of instructions to be executed by processor 604. Such instructions, when stored in storage media accessible to processor 604, render computer system 600 into a special-purpose machine that is customized to perform the operations specified in the instructions. The computer system 600 further includes a read-only memory (ROM) 608 or other static storage device coupled to bus 602 for storing static information and instructions for processor 604. A storage device 610, such as a magnetic disk, optical disk, or USB thumb drive (Flash drive), etc., is provided and coupled to bus 602 for storing information and instructions.

The computer system 600 may implement the techniques described herein using customized hard-wired logic, one or more ASICs or FPGAs, firmware, and/or program logic which in combination with the computer system causes or programs computer system 600 to be a special-purpose machine. According to one embodiment, the techniques herein are performed by computer system 600 in response to processor(s) 604 executing one or more sequences of one or more instructions contained in main memory 606. Such instructions may be read into main memory 606 from another storage medium, such as storage device 610. Execution of the sequences of instructions contained in main memory 606 causes processor(s) 604 to perform the process steps described herein. In alternative embodiments, hard-wired circuitry may be used in place of or in combination with software instructions.

The main memory 606, the ROM 608, and/or the storage 610 may include non-transitory storage media. The term “non-transitory media,” and similar terms, as used herein refers to a media that stores data and/or instructions that cause a machine to operate in a specific fashion. The media excludes transitory signals. Such non-transitory media may include non-volatile media and/or volatile media. Non-volatile media includes, for example, optical or magnetic disks, such as storage device 610. Volatile media includes dynamic memory, such as main memory 606. Common forms of non-transitory media may include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, an EPROM, a FLASH-EPROM, NVRAM, any other memory chip or cartridge, and networked versions of the same.

The computer system 600 also includes a network interface 618 coupled to bus 602. Network interface 618 provides a two-way data communication coupling to one or more network links that are connected to one or more local networks. For example, network interface 618 may be an integrated services digital network (ISDN) card, cable modem, satellite modem, or a modem to provide a data communication connection to a corresponding type of telephone line. As another example, network interface 618 may be a local area network (LAN) card to provide a data communication connection to a compatible LAN (or WAN component to communicated with a WAN). Wireless links may also be implemented. In any such implementation, network interface 618 sends and receives electrical, electromagnetic, or optical signals that carry digital data streams representing various types of information.

The computer system 600 can send messages and receive data, including program code, through the network(s), network link, and network interface 618. In the Internet example, a server might transmit a requested code for an application program through the Internet, the ISP, the local network, and the network interface 618.

The received code may be executed by processor 604 as it is received, and/or stored in storage device 610, or other non-volatile storage for later execution.

Each of the processes, methods, and algorithms described in the preceding sections may be embodied in, and fully or partially automated by, code modules executed by one or more computer systems or computer processors including computer hardware. The processes and algorithms may be implemented partially or wholly in application-specific circuitry.

The various features and processes described above may be used independently of one another, or may be combined in various ways. All possible combinations and sub-combinations are intended to fall within the scope of this disclosure. In addition, certain method or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The exemplary blocks or states may be performed in serial, in parallel, or in some other manner. Blocks or states may be added to or removed from the disclosed exemplary embodiments. The exemplary systems and components described herein may be configured differently than described. For example, elements may be added to, removed from, or rearranged compared to the disclosed exemplary embodiments.

The various operations of exemplary methods described herein may be performed, at least partially, by an algorithm. The algorithm may be included in program codes or instructions stored in a memory (e.g., a non-transitory computer-readable storage medium described above). Such algorithm may include a machine learning algorithm. In some embodiments, a machine learning algorithm may not explicitly program computers to perform a function, but can learn from training data to make a predictions model that performs the function.

The various operations of exemplary methods described herein may be performed, at least partially, by one or more processors that are temporarily configured (e.g., by software) or permanently configured to perform the relevant operations. Whether temporarily or permanently configured, such processors may constitute processor-implemented engines that operate to perform one or more operations or functions described herein.

Similarly, the methods described herein may be at least partially processor-implemented, with a particular processor or processors being an example of hardware. For example, at least some of the operations of a method may be performed by one or more processors or processor-implemented engines. Moreover, the one or more processors may also operate to support performance of the relevant operations in a “cloud computing” environment or as a “software as a service” (SaaS).

Any process descriptions, elements, or blocks in the flow diagrams described herein and/or depicted in the attached figures should be understood as potentially representing modules, segments, or portions of code which include one or more executable instructions for implementing specific logical functions or steps in the process. Alternate implementations are included within the scope of the embodiments described herein in which elements or functions may be deleted, executed out of order from that shown or discussed, including substantially concurrently or in reverse order, depending on the functionality involved, as would be understood by those skilled in the art.

As used herein, the term “or” may be construed in either an inclusive or exclusive sense. Moreover, plural instances may be provided for resources, operations, or structures described herein as a single instance. Additionally, boundaries between various resources, operations, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the exemplary configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

Although an overview of the subject matter has been described with reference to specific exemplary embodiments, various modifications and changes may be made to these embodiments without departing from the broader scope of embodiments of the present disclosure. Such embodiments of the subject matter may be referred to herein, individually or collectively, by the term “invention” merely for convenience and without intending to voluntarily limit the scope of this application to any single disclosure or concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

What is claimed is:

1. A computer-implemented method for machine learning and application at a ride-hailing platform, comprising:
training, by one or more computing devices, a machine learning model with training data to obtain a long-term value model, wherein the training data comprises a plurality of series of temporally-sequenced user bubbling events, wherein each of the user bubbling events corresponds to a historical transportation query from a user device and a historical response including a historical discount signal from a server, and wherein the long-term value model is configured to predict long-term values for respectively applying different discount signals to a given transportation plan of given bubbling features;
obtaining, by the one or more computing devices, a plurality of bubbling features of a transportation plan of a user, wherein the plurality of bubbling features comprise (i) a bubble signal comprising time information and location information corresponding to the transportation plan, (ii) a supply and demand signal comprising transportation supply-demand information corresponding to the transportation plan, and (iii) transportation order history information of the user;
determining, by the one or more computing devices, a discount signal based at least on feeding the plurality of bubbling features to the long-term value model; and
transmitting, by the one or more computing devices, the discount signal to a computing device of the user.

2. The method of claim 1, further comprising:
collecting, by the one or more computing devices, historical user bubbling events corresponding to the historical users bubbling at different historical times; and
formulating, by the one or more computing devices, historical user bubbling events of each of the historical users into a Markov Decision Process (MDP) trajectory to obtain the plurality of series of temporally-sequenced user bubbling events.

3. The method of claim 2, wherein:
the historical user bubbling events respectively correspond to transitions in reinforcement learning;
the method further comprises assigning greater weights to transitions with greater temporal difference (TD) errors, more recent transitions, and/or stochastic transitions; and
training the machine learning model with training data comprises randomly sampling the transitions from the training data according to the assigned weights.

4. The method of claim 2, wherein:
the MDP trajectory comprises a quintuple (S, A, T, R, γ);
S represents a state space comprising a plurality of states corresponding to the bubbling features of the historical users;
A represents an action space comprising a plurality of actions corresponding to the historical discount strategies applied to the historical users;
T represents a state transition model based on S and A;
R represents a reward function based on S and A; and
γ represents a discount factor of a cumulative reward.

5. The method of claim 4, wherein training the machine learning model comprises:
enabling a reinforcement learning agent to, until reaching a terminal state, learn from interactions with a reinforcement learning environment, wherein the reinforcement learning agent is configured to observe a state s from the environment, select an action α given by a policy π to execute in the environment, and then observe a next state s+1 and obtain a reward r corresponding to the state transition from s to s+1 with the action α, wherein the policy π is based at least on one or more weights and/or one or more biases; and
optimizing the policy π based at least on tuning the one or more weights and/or the one or more biases.

6. The method of claim 5, wherein:
the state s corresponds to a historical bubbling event;
the action α corresponds to a historical discount signal; and
the reward r is based at least on a product between (i) a price of a historical transportation completed from the historical bubbling event and (ii) a change between a first conversion rate of conversion from a bubbling event to a transportation order with discount and a second conversion rate of conversion from a bubbling event to a transportation order without discount.

7. The method of claim 4, wherein the plurality of actions comprise:
a number (N) of discrete discounts and no discount.

8. The method of claim 5, wherein optimizing the policy π comprises:
applying a double-Q learning algorithm configured to maximize an expectation of the cumulative reward subject to the discount y and optimize the selection of the action α from the plurality of actions of the action space.

9. The method of claim 5, wherein:
the machine learning model comprises a representation encoder, a dueling network, and an aggregator;
the dueling network comprises a first stream and a second stream configured to share the encoder and outcouple to the aggregator;
the first stream is configured to estimate the reward r corresponding to the state s and the action α; and
the second stream is configured to estimate a difference between the reward r and an average.

10. The method of claim 1, wherein:
the location information comprises an origin location of the transportation plan of the user, a destination location of the transportation plan, a distance between the origin location and the destination location, and a route departing from the origin location and arriving at the destination location;
the time information comprises a timestamp, and a vehicle travel duration along the route; and
the transportation supply-demand information comprises a number of passenger-seeking vehicles around the origin location and a number of vehicle-seeking transportation orders departing from the origin location.

11. The method of claim 10, wherein:
the origin location of the transportation plan of the user comprises a geographical positioning signal of the computing device of the user; and
obtaining the supply and demand signal comprises:
obtaining, from a plurality of computing devices of a plurality of vehicle drivers, a plurality of geographical positioning signals respectively corresponding to the plurality of computing devices of the plurality vehicle drivers; and
determining the number of passenger-seeking vehicles around the origin based on the plurality of geographical positioning signals and the geographical positioning signal of the computing device of the user.

12. The method of claim 11, wherein:
the geographical positioning signal comprises a Global Positioning System (GPS) signal; and
the plurality of geographical positioning signals comprise a plurality of GPS signals.

13. The method of claim 10, wherein the location information further comprises one or more of the following:
a weather condition at one or more locations along the route; and
a traffic condition at one or more locations along the route.

14. The method of claim 10, wherein:
the bubble signal further comprises a price quote corresponding to the transportation plan; and
the method further comprises presenting, by the computing device of the user, the discount signal, the route, and the price quote.

15. The method of claim 14, further comprising:
receiving, by the one or more computing devices, from the computing device of the user, an acceptance signal comprising an acceptance of the transportation plan of the user, the price quote, and a price discount corresponding to the discount signal; and
transmitting, by the one or more computing devices, the transportation plan to a computing device of a vehicle driver for fulfilling the transportation order.

16. The method of claim 1, wherein the transportation order history information of the user comprises one or more of the following:
a frequency of order transportation order bubbling by the user;
a frequency of transportation order completion by the user;
a history of discount offers provided to the user in response to the order transportation order bubbling; and
a history of responses of the user to the discount offers.

17. The method of claim 1, wherein the long-term value model is configured to:
generate a value matrix that maps to combinations of different users and different discount signals; and
automatically perform discount signal determination based on the given bubbling features and the value matrix to optimize a long-term return to the ride-hailing platform and comply with a budget constraint.

18. One or more non-transitory computer-readable storage media storing instructions executable by one or more processors, wherein execution of the instructions causes the one or more processors to perform operations comprising:
training a machine learning model with training data to obtain a long-term value model, wherein the training data comprises a plurality of series of temporally-sequenced user bubbling events, wherein each of the user bubbling events corresponds to a historical transportation query from a user device and a historical response including a historical discount signal from a server, and wherein the long-term value model is configured to predict long-term values for respectively applying different discount signals to a given transportation plan of given bubbling features;
obtaining a plurality of bubbling features of a transportation plan of a user, wherein the plurality of bubbling features comprise (i) a bubble signal comprising time information and location information corresponding to the transportation plan, (ii) a supply and demand signal comprising transportation supply-demand information corresponding to the transportation plan, and (iii) transportation order history information of the user;
determining a discount signal based at least on feeding the plurality of bubbling features to the long-term value model; and
transmitting the discount signal to a computing device of the user.

19. The one or more non-transitory computer-readable storage media of claim 18, wherein the operations further comprise:
collecting historical user bubbling events corresponding to the historical users bubbling at different historical times; and
formulating historical user bubbling events of each of the historical users into a Markov Decision Process (MDP) trajectory to obtain the plurality of series of temporally-sequenced user bubbling events.

20. A system comprising one or more processors and one or more non-transitory computer-readable memories coupled to the one or more processors and configured with instructions executable by the one or more processors to cause the system to perform operations comprising:
training a machine learning model with training data to obtain a long-term value model, wherein the training data comprises a plurality of series of temporally-sequenced user bubbling events, wherein each of the user bubbling events corresponds to a historical transportation query from a user device and a historical response including a historical discount signal from a server, and wherein the long-term value model is configured to predict long-term values for respectively applying different discount signals to a given transportation plan of given bubbling features;
obtaining a plurality of bubbling features of a transportation plan of a user, wherein the plurality of bubbling features comprise (i) a bubble signal comprising time information and location information corresponding to the transportation plan, (ii) a supply and demand signal comprising transportation supply-demand information corresponding to the transportation plan, and (iii) transportation order history information of the user;
determining a discount signal based at least on feeding the plurality of bubbling features to the long-term value model; and
transmitting the discount signal to a computing device of the user.
